(19) United States
(12) Patent Application Publication
(10) Pub. No.: US 2018/0336545 A1
(43) Pub. Date: Nov. 22, 2018

(54) METHOD AND SYSTEM FOR PAYMENT HANDLING

(71) Applicant: QIBIXX AG, Buchs (CH)

(72) Inventor: Johannes RIETSCHEL, Zurich (CH)

(73) Assignee: Qibixx AG, Buchs (CH)

(21) Appl. No.: 15/771,512

(22) PCT Filed: Oct. 24, 2016
(86) PCT No.: PCT/EP2016/075515

§ 371 Date: Apr. 27, 2018

(30) Foreign Application Priority Data
Oct. 29, 2015 (EP) 15192180.6
Nov. 24, 2015 (CH) 01713/15

(51) Int. Cl. G06Q 20/26; G06Q 20/32; G06Q 20/40; G06Q 20/34

(52) U.S. Cl. CPC G06Q 20/26; G06Q 20/3223; G06Q 20/3415; G06Q 20/3276; G06Q 20/401

(57) ABSTRACT

A method for simple and secure payment handling includes at least the following steps: transmission of identification information to a mobile device (MG); transmission of the purchase sum into a terminal (T); connection of the debit card to the terminal (T); transmission of purchase sum and identification information (ID) from the terminal (T) to a payment institution (ZI); transmission of payment sum and identification information (ID) from the payment institution (ZI) to a coordination entity (KI); association of the identification information (ID) with the mobile device (MG) and transmission of the purchase sum to the mobile device (MG) for authorisation; in the event of verification of the purchaser, transmission of the authorisation via the coordination entity (KI) to the payment institution (ZI) and prompting of debiting of an account of the purchaser; transmission of confirmation of the payment from the payment institution (ZI) to the terminal (T).

### TECHNICAL FIELD

The present invention relates to a method and an apparatus (system) for securely handling a payment, in particular largely using existing infrastructure and with the capability of simple use.

### PRIOR ART

In many countries today, payments are now handled using cash only to a decreasing extent. Payments today are increasingly made using debit cards (credit cards, payment cards) that have a magnetic strip and/or a chip for secure identification. Particularly the handling of payments in everyday life involves a procedure to the effect that there is a terminal for the debit cards at the payment station, the vendor uses this terminal or a connected cash register to input the amount to be paid, the purchaser pushes his debit card into the terminal or brings it close enough to the terminal for the card information to be able to be transferred to the terminal, then after or at the same time as the amount is presented on the terminal a pin code is input by the purchaser using an input interface (keypad) provided on the terminal, and this authorizes the relevant amount to be debited from the account associated with the debit card.

A problem with this method of payment that has now become established worldwide is, inter alia, the fact that the users are compelled to carry debit cards with applicable annual fees and commissions and it is also a problem that customers today frequently have a large number of cards, and there is not enough clarity.

Accordingly, there are now also systems for payment handling that are based on the mobile phone. In this case, an app on the mobile phone is used to securely manage a credit or directly a connection to a payment institution and association within an account, and the payment is handled via a wireless interface at the payment station. The interface used may be WLAN or Bluetooth, the payment is thus made simply and, if appropriate algorithms are used, also securely, and the user no longer needs to carry a wallet when he goes shopping, his mobile phone being with him anyway.

A problem with this method of payment is that additional infrastructure is required at the payment stations in order to ensure the communication between the mobile phone of the user and the applicable database or infrastructure of the vendor. While such systems per se are superior to the debit-card-based systems today, the reason for them failing to be established on the market is frequently precisely the additional infrastructure and the lack of standardization.

This is the starting point for the present invention.

### PRESENTATION OF THE INVENTION

It is accordingly, inter alia, the object of the present invention to provide an improved mobile payment method that requires as little additional hardware as possible and can be introduced without great complexity and with only a slight change in user behavior.

The subject matter of the present invention is accordingly a method according to claim 1, a system according to claim 12 and a debit card according to claim 13 or 14.

Specifically, the present invention relates to a method for payment handling at a payment station of a vendor using a mobile device of a purchaser, wherein the payment station has a terminal equipped for debit cards, and the terminal is normally equipped with a card port (insertion slot, approach area), a display, an input apparatus (numeric keypad, touch-sensitive display) and an interface to a payment institution. In addition, a debit card suitable for said terminal and/or the terminal or another location linked to the terminal is/are equipped with an element for wirelessly transmitting a piece of debit-card-specific identification information to the mobile device. This may be a sticker (for example with a QR code, barcode, or the like), the applicable identification information can, however, also be made available on the display of the terminal or another display at the premises of the terminal, it likewise being possible for the identification information to be transmitted wirelessly, for example via a low energy Bluetooth connection.

In this case, the proposed payment handling has at least the following steps, the order of the first 4 steps (ID transmission, purchase price input, mobile payment triggering with debit card or input on the terminal, transmission to the KI) being able to be as indicated, but the first step (ID transmission) also being able to be effected after or during step 2 and/or step 3 and/or step 4:
transmission of the identification information to the mobile device (MG) (this step can be effected actively or passively by the provider of the identification information, e.g. also by reading a QR code, barcode, a scannable identification identifier, or the like with the mobile device (MG));
transmission or input of the purchase price into the terminal (T) and/or the mobile device (MG);
connection of the debit card to the terminal (T) via the card port and/or triggering of a terminal-specific identifier via an input on the terminal;
and then either:
   transmission of the purchase price and the identification information (ID) from the terminal (T) to a payment institution (ZI);
   transmission of the purchase price and the identification information (ID) from the payment institution (ZI) to a coordination entity (KI), unless the payment institution (ZI) itself provides the coordination entity (KI);
   association of the identification information (ID) with the mobile device (MG) and transmission of the purchase price to the mobile device (MG) for authorization;
      or (e.g. if the card is a card identifiable as special by the terminal and the terminal is itself already able, on this basis, to route the data directly to the coordination entity (KI), i.e. not via a payment institution (ZI))
   transmission of the purchase price and the identification information (ID) from the terminal directly to a coordination entity (KI),
      in the absence of verification of the purchaser on the mobile device (MG), termination of the process, and
in the event of verification of the purchaser on the mobile device (MG) or a change to the purchase price by the purchaser on the mobile device (MG), transmission of the authorization from the mobile device (MG) via the coordination entity (KI) of the payment institution (ZI) or only to the coordination entity (KI) and prompting of the debiting of an account of the purchaser to the extent of the purchase price, including any charges incurred;
transmission of confirmation of the payment from the payment institution (ZI) or the coordination entity (KI) to the terminal (T).

In the step indicated as the 3rd step above (mobile payment triggering), one option is for the triggering to be effected via the connection of the debit card, but it is also possible to trigger this step via a key input, for example. The actual debit card is not absolutely necessary, provided that an identifier stored in the terminal, which identifier includes the identifier of the debit card for identification with the coordination entity and/or with the payment institution, for example, or allows a correlation with the identifier of the debit card at the applicable points, is on hand. At the terminal, there is then no longer even any need to use a debit card for the payment process. It is possible for a debit card to be presented to the terminal once after switching on or just at the beginning of every work shift and for the relevant information to be stored in the terminal, so that the person responsible for the terminal can then perform the relevant process by means of an input on the screen or on the keypad in order to trigger the mobile payment. For the sake of security, there may additionally also still be provision for a pin code or something similar for the triggering.

In this manner, it is essentially possible to use existing hardware, which is designed for the usual debit-card-based purchase processes, to implement a mobile payment too, the only additional hardware that needs to be provided being the actually unusual vendor-specific debit card that is introduced into the terminal, and appropriately amended processes needing to be implemented with the payment institution and with the coordination entity, or, if the card is a card identifiable as special by the terminal and the terminal is itself already able, on this basis, to route the data directly to the coordination entity (KI), with the coordination entity, so that a transaction can be handled.

According to a 1st preferred embodiment of the present invention, the method is characterized in that the identification information is a code readable via a camera of the mobile device, preferably a QR code, and/or is a piece of identification information readable via a wireless interface, preferably via a Bluetooth interface, particularly preferably via a low-energy Bluetooth interface of the mobile device (MG). This information may be provided e.g. on the debit card or on the terminal.

If the debit card is equipped with a low-energy Bluetooth chip that is supplied with power on coupling of the debit card in the card port of the terminal (T) and uses a short-range secure data transmission to transmit the identification information to the mobile device, particularly simple information transmission that is largely manipulation-free for the purchaser can be ensured.

More specifically, the method according to a further preferred embodiment has the following steps, unless specified otherwise in the following order:
1. transmission of the identification information to the mobile device, preferably by optical or Bluetooth transmission;
2. transmission or input of the purchase price into the terminal, preferably by input of the purchase price via a keypad on the terminal and connection of the debit card to the terminal via the card port, preferably by pushing it into a card slot;
   wherein steps 1 and 2 can also be performed at the same time or in the inverse order;

and then either:
3a. transmission of the purchase price and the identification information from the terminal to a payment institution using a secure data line;
4a. transmission of the purchase price and the identification information from the payment institution to a coordination entity, unless the payment institution itself provides the coordination entity, again using a secure data line;
   or (if e.g. the card is a card identifiable as special by the terminal and the terminal is itself already able, on this basis, to route the data directly to the coordination entity (KI)):
3b./4b. transmission of the purchase price and the identification information from the terminal to the coordination entity using a secure data line (steps 3b/4b are therefore drawn together into one step);

and then:
5. association of the identification information with the mobile device in the or by the coordination entity;
6. transmission of the purchase price to the mobile device for authorization;
7. presentation of the amount and the authorization facility on the mobile device via an appropriate piece of software installed on the mobile device; in the absence of verification of the purchaser on the mobile device by manual input or voice input, termination of the process, and
   in the event of authorization of the purchaser on the mobile device by manual input or voice input,
8. transmission of the authorization from the mobile device to the coordination entity;
9. transmission of the authorization with associated identification information to the payment institution (this step is required only if the coordination entity does not communicate directly with the terminal, i.e. if e.g. the card is not a card identifiable as special by the terminal and the terminal is itself already able, on this basis, to route the data directly to the coordination entity (KI));
10. transmission of the authorization, if need be with associated identification information, to the terminal;
11. output of the authorization, preferably via a display and/or a printout, on the terminal.

The debiting of the account of the purchaser can be effected via the coordination entity and/or via the payment institution, the debiting of an account of the purchaser at another payment institution preferably being effected via the coordination entity.

The mobile device may be a tablet or a smartphone.

The terminal is preferably a conventional terminal for handling debit cards in the form of credit cards, bank cards, Maestro cards, particularly preferably for chip cards based on ISO/IEC 14443 and/or ISO/IEC 7816.

The debit card is preferably a debit card that is associated with an account of the vendor at the payment institution and that additionally bears the identification information, preferably in the form of a QR code readable with the mobile device or in the form of a Bluetooth Low Energy chip.

If a beacon (Bluetooth Low Energy device) is used, then it is also possible for the identification information to be provided in secure form. As such, it is then possible for the identification information to be a piece of encrypted information, for example, including in time-dependent fashion, for example, for example using a standard product as available from RSA Security Inc.

The identification information can, as stated, be provided via a beacon provided on the debit card, but it is also possible for such a beacon to be provided on the terminal. When supplied with power via a USB interface on such a terminal, for example, such a beacon then does not need to be integrated in the software of the terminal.

Preferably no monetary transaction or only a temporary monetary transaction is performed on the account of the vendor that is managed at the payment institution, unless the communication takes place directly and only via the coordination entity, and that is associated with the debit card, but rather this account is provided only for the communication between the terminal and the payment institution that is effected using existing infrastructure, whereas the actual monetary transaction is effected via the coordination entity and with reference to an account of the purchaser and another account of the vendor, the two of which do not necessarily have to be managed at the payment institution.

The communication between the terminal and the payment institution and/or the communication between the payment institution and the coordination entity and/or the communication between the coordination entity and the mobile device and/or the communication between the debit card and the terminal and/or the communication between the payment institution and the terminal directly is/are effected preferably in encrypted form.

The identification information stored on the debit card and read by the mobile device either optically or via Bluetooth is preferably a different piece of identification information than the one that is identification information interchanged for identification and association of the process between the debit card and the terminal, and/or between the terminal and the payment institution, and/or between the payment institution and the coordination entity, and/or between the terminal and the coordination entity, but the respective specifically transmitted identification information is stored in such a correlated fashion, or in databases, that, preferably at any time, an explicit association between the specific debit card used, the specific mobile device used at this moment, or the SIM card thereof, and preferably also the currently performed payment is possible.

Moreover, the present invention relates to a system preferably for performing a method, as has been presented above, characterized in that it comprises

a terminal having a card port, a display, an input apparatus and a preferably secure interface to a payment institution and/or a coordination entity;

a debit card having an element for wireless transmission of a piece of identification information to the mobile device, and having a magnetic strip and/or chip for debit-card-specific information transmission to the terminal;

a payment institution and/or coordination entity in communication with the terminal and having an account of the vendor that is associated with the debit card;

a coordination entity in communication with the payment institution, unless the communication is effected directly between the coordination entity and the terminal;

a portable mobile device of the purchaser having an interface for receiving or for reading the identification information from the debit card and an interface for communication with the coordination entity.

In addition, the present invention relates to a debit card, particularly for use in a method, as has been described above, and particularly preferably as part of a system, as has likewise been described above, having an element in the form of a QR code and/or a Bluetooth Low Energy component for wireless transmission of a piece of identification information to the mobile device, and having a magnetic strip and/or chip for debit-card-specific information transmission to the terminal.

Such a debit card may additionally preferably be characterized in that besides a chip for debit-card-specific information transmission to the terminal, the debit card has a Bluetooth Low Energy chip arranged on it that is supplied with power by the terminal in the event of interaction with the terminal and that is provided for short-range transmission of the identification information to the mobile device.

Further embodiments are specified in the dependent claims.

### BRIEF DESCRIPTION OF THE DRAWINGS

Preferred embodiments of the invention are described below with reference to the drawings, which are used merely for explanation and are not intended to be interpreted as limiting. In the drawings:

FIG. 1 shows the different elements in the proposed payment system; and

FIG. 2 shows a flowchart for a payment sequence in such a payment system.

### DESCRIPTION OF PREFERRED EMBODIMENTS

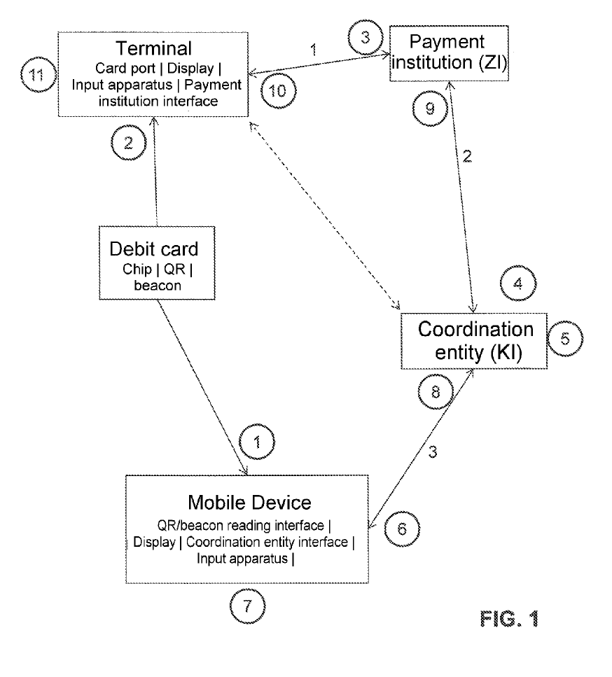

A system that is suitable for performing a payment method as has been described above is depicted schematically in FIG. 1.

It comprises a mobile device MR of a purchaser, typically a smartphone or a tablet, that is explicitly identified and is connected to a telecommunication network and the Internet via a SIM card, for example. It thus has an interface that is suitable for setting up a secure connection to a coordination entity (cf. description further below). In addition, it has a processor and memory in order to run appropriate software (app) for controlling the payment process. Moreover, the mobile device has a reading interface, for example a camera or Bluetooth, that allows information to be obtained from the payment office. In addition, the mobile device has an input facility, typically a keypad or a touch-sensitive display.

In addition, the system comprises a debit card D that the vendor carries and that, as a departure from the usual payment processes, is precisely not held by the purchaser. This debit card is per se a standard debit card, a debit card being understood in the present context to mean generally, i.e. including in connection with the general description, a card that allows access to an account at a payment institution or prompts debiting or inversing via a credit card institution. The debit card is thus a bank card, a credit card or the like, or a Maestro card or the like is likewise possible. The debit card has an information storage medium (magnetic strip and/or chip) that allows an association with an account managed at a payment institution (ZI) (or analogously a credit card institution) to be made in the or by approaching a terminal. It is thus essentially a conventional debit card. Additionally, this debit card now also has a specific piece of identification information that can be read by the mobile device of the purchaser, however. This is either a barcode, or a QR code, or else a chip that can use Bluetooth Low Energy to wirelessly transmit identification information stored on the chip to the mobile device over a short distance. Alternatively, it is possible for this identification information, which ultimately allows a correlation between the account at the payment institution that is associated with the debit card and the mobile device, to be provided on the terminal (for example sticker with QR code on the terminal) so that the card can remain in the slot of the terminal when the information is meant to be read by the mobile device.

In addition, the system comprises an inherently conventional terminal T for handling payment processes with a debit card. In other words, the usual terminal kept at restaurants and sales outlets with a small numeric keypad as input apparatus, a small display and a card port, typically an insertion slot for the debit card. The great advantage of the proposed method is precisely that just a conventional terminal can be used to perform the method and no specific additional hardware needs to be provided.

In addition, the system comprises a payment institution ZI that is associated with the debit card and manages an account of the vendor of this debit card. This is a further important difference from the conventional payment process, where simply the debit card of the purchaser is used in the terminal, and the involvement of the payment institution in connection with the present technique is merely setting up a secure and direct connection to a coordination entity KI, but not performing the actual monetary transaction at this payment institution.

Finally, the system comprises a coordination entity KI that ensures firstly secure communication with the mobile device and secondly secure communication with the payment institution. The coordination entity and the payment institution can also coincide in principle. The coordination entity is ultimately the central processing station in this method, since it provides the correlation between the transmissions of purchase amount and identification of the debit card, or of the account of the vendor (which is not used for the monetary transaction), which are effected via debit card, terminal and payment institution, and the information about the purchaser or his mobile device and the account of the vendor and the account of the purchaser. The coordination entity accordingly also prompts the actual monetary transaction, which may be either the debiting of an account of the purchaser and crediting of an account of the vendor, or else also crediting of an account of the vendor and debiting of a credit of the purchaser on the mobile device or at the coordination entity.

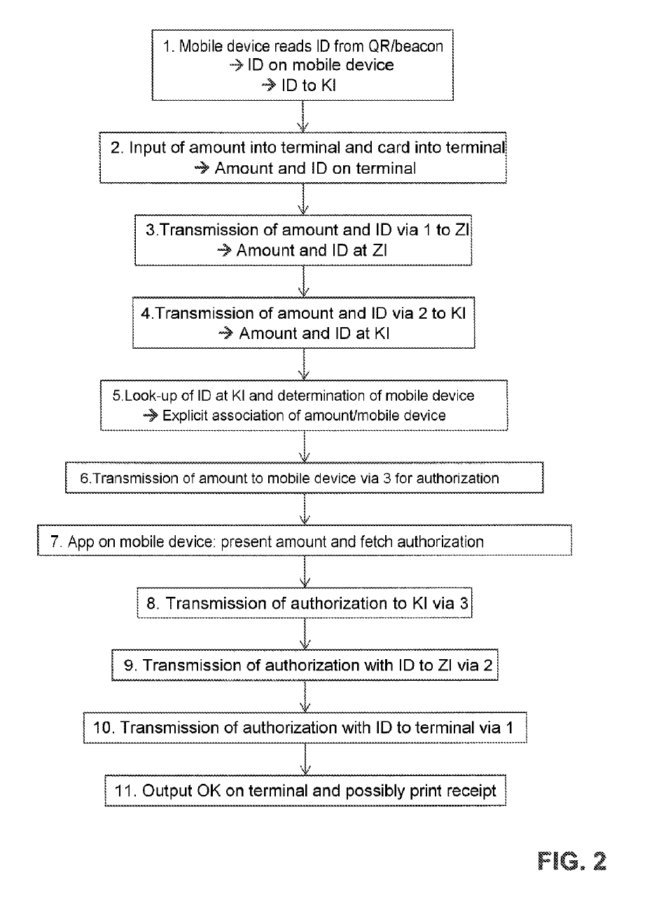

Alternatively, it is possible, if the card is a card identifiable as special by the terminal and the terminal is itself already able, on this basis, to route the data directly to the coordination entity, for the communication to take place directly, as depicted by the dashed arrow in FIG. 1, between the terminal and the coordination entity and for the coordination entity either to keep and manage accounts of the vendor and the purchaser itself or to debit or credit accounts at payment institutions. In FIG. 2, steps 3 and 4 are then replaced by a single step of transmission of amount and ID from terminal to K1 (dashed arrow in FIG. 1)→amount and ID at KI, and step 9 is superfluous, since the authorization is effected directly from the coordination entity to the terminal.

The method shall be explained further on the basis of the flowchart shown in FIG. 2, wherein the numbers of the individual boxes as shown in FIG. 2 are each shown in circles in the schematic depiction in FIG. 1 so that the process can be comprehended using both figures.

In a 1st step, the mobile device reads a piece of identification information from the debit card or possibly also from the terminal. This is either by virtue of a QR code being read via a camera of the mobile device or by virtue of a short-range connection between debit card and mobile device being set up via Bluetooth Low Energy and the identification information being transmitted to the mobile device over a short range.

In the 2nd step, which can also be effected in parallel with or even before the 1st step, input of the purchase amount is performed in the terminal or the purchase amount is transmitted to the terminal via a data station connected to the terminal. The card is introduced into the terminal if this has not already happened, and the information specific to the debit card that allows said debit card to be associated with an account at a payment institution is transmitted to the terminal, typically via an encrypted connection.

In the 3rd step, the purchase amount and the identification information associated with the debit card are transmitted to the payment institution via the data line 1.

At the payment institution, an account of the purchaser that is associated with the debit card is then not requested in the usual way, but rather in the 4th step, an appropriate piece of information is associated with this debit card at the payment institution, essentially simply just the purchase amount and an association with the vendor are transmitted to a coordination entity.

In the 5th step, the coordination entity now first of all looks for which mobile device has recently read the information associated with the debit card in the QR code, this ideally being done without losing any time so that the app on the mobile device transmits this association to the coordination entity immediately after reading the information from the debit card, and the association is already available in a look-up table at the coordination entity at the time at which the information comes from the payment institution. As such, an explicit correlation is produced between the specifically used mobile device (or the SIM card thereof), the individual specific payment process and the vendor.

In the next, 6th step, the coordination entity then transmits the payment amount to the mobile phone, typically via a secure Internet connection.

In the 7th step, this information received by the app on the mobile phone is processed by virtue of the purchase amount being presented on the display and an input request being made to authorize this purchase amount. If need be, security can also be increased further by virtue of a pin or the like being requested by this app in a 1st step. It is either possible for the authorization of the purchase amount to entail the purchase amount being debited from an account of the purchaser, or a credit held on the mobile device and/or at the coordination entity can also simply be reduced.

If no verification or authorization by the user or purchaser is effected on the mobile device, the process is terminated. By way of example, it is possible to provide for the purchase process to be terminated automatically if no authorization is received at the coordination entity within a particular time period.

If verification or authorization by the purchaser is effected on the mobile phone, this authorization is in turn transmitted to the coordination entity in the 8th step. The coordination entity then either directly prompts a debit from the account or a credit of the purchaser and a credit to an account of the vendor, these accounts both admittedly being able to be managed at the payment institution, but readily also being able to be managed at another payment institution, or the debits are made only when a completion acknowledgement has been provided by the terminal according to step 11, described further below.

In the 9th step, the authorization with the identification of the user account (of the vendor) is transmitted to the payment institution.

In the 10th step, the authorization with the identification of the debit card (of the purchaser) is transmitted to the terminal.

In the 11th step, a confirmation of payment is shown on the display on the terminal and/or a receipt is printed, if required.

If debiting is not effected directly in step 8 above, but rather, for the sake of security, it is necessary to wait until the confirmation has also actually been output on the terminal, inter alia also because the process has possibly still also been terminated on the terminal in between, this confirmation can in turn be transmitted via the communication channels 1 and 2 securely to the coordination entity, and this debits only when this confirmation has also been received.

More specifically, this concept shall now be presented subsequently, and essentially involves proposing a concept for how a restaurateur or another trader, for example, can use a mobile payment platform at no cost and without additional hardware infrastructure.

In practice, restaurateurs all have a mobile credit card reader that they take to the table when a customer wants to pay by card. Other small traders sometimes have a permanently installed device. The waiter does not want to take another, second device for mobile payment acceptance to the table with him, and his private mobile phone cannot be used either. How, then, can a customer pay by mobile payment?

Solution (user's perspective, non-technical):
The trader is provided with a “merchant chipcard” by the mobile payment provider on signing up. This does not need to be personalized and does not need to have an inscription.
If the customer wants to pay by mobile payment, the waiter has the customer scan the back of the card (QR code). The waiter then inputs the amount to be paid into the card terminal and inserts this “mobile payment” card into the card terminal on hand. He possibly still inputs the PIN if this cannot be turned off.
Next, the customer receives the amount and the request to confirm it in the mobile payment app (“wait for amount”).
The customer gives his OK—as with any “normal” card—and the card terminal confirms the payment (transaction OK) and prints a receipt for the waiter (customer will have the transaction in due course, does not need a receipt, but could obtain one).
The waiter removes the card again from the terminal.

The sequence of the payment is thus very simple, for the customer as simple as mobile payment with a merchant app (scan barcode), for the waiter as simple as a debit card transaction, the device not needing to be given to the customer and the customer also not needing to input a PIN.

A possible technical implementation can have the following appearance:

The mobile payment provider as coordination entity requests one postal account per trader from a payment institution. These “trader accounts” are virtual accounts that will never have a credit or genuine transactions. The accounts can be generated en bloc “in advance” as sub accounts by the mobile payment provider without problems (e.g.: 1000 accounts in “reserve”).

The payment institution has “normal” debit cards produced for these accounts by the normal manufacturer. The back of the cards has a random or sequential “pairing code” (QR) put on. This can also be done using a sticker. The code can also be produced and delivered on a simple laminated “trader card” independently of the card.

At the payment institution, an expansion (a single WEB/service call) is incorporated in the module that checks the account balance for a debit transaction online. A call is already made to an “online fraud check” or “online risk change” that can be used therefor.

This call is made ONLY for mobile payment provider accounts (identifiable from the ID number) instead of the normal risk/fraud call. If there is not yet any such call, it is made at the point at which the credit in the account is checked.

The call uses a return code to return an “OK” or “not OK”. Accordingly, the “transaction” is then completed in positive or negative fashion on the payment institution backend. In the positive case, the amount should, if possible, NOT be debited from the account (balance always remains at 0)—but, if this cannot be changed, this is also not a problem, since it can be settled at the end of the day.

This is everything that needs to be done at the payment institution end.

In summary once again: “normal” account management at payment institution, mobile payment provider as coordination entity simply has one sub account per trader under its ID number at the payment institution, said sub account not even needing to be associated by name at the payment institution. The trader does not see the account, it is a mobile payment provider account.

For the account, there is a “totally normal” debit card.

In the event of debit transactions on these accounts, instead of balance and risk management, a web/service call is used for the accept transaction yes/no decision. OPTIONAL: the amount is not entered, not even in the “OK” case. The transaction is concluded as with “normal” transactions, however.

At the mobile payment provider end, as coordination entity, the following functionality can be provided either in the backend (if resources available) or else independently (cloud based “checkout software”):

The payment institution service call calls a backend process. The latter has the amount and the debit card/account number transmitted to it in the service call.

The account number or debit card number can be explicitly associated with a trader/merchant card. The associated pairing code can be looked for by means of look-up (in the simplest case, the debit card number is simultaneously a pairing code, but for security reasons it makes more sense to take a “different” code).

The backend process (as stated, may also be outside the mobile payment provider/backend) gives a “start order” with the pairing code and requests the amount via the “normal” mobile payment provider merchant interfaces.

Mobile payment provider as coordination entity identifies the associated mobile of the customer from the pairing code, fetches the confirmation for the amount from the customer and confirms the transaction to the web service. The latter concludes the payment institution service call with the appropriate return code.

In the mobile payment provider system, the transaction is entered normally in the trader account.

If the payment institution system is to debit the amount from the trader/debit card (the transaction needs to be carried out with the amount), then all transactions on the trader account with the merchant card are added together at the end of the day during reconciliation and an appropriate credit transaction is transmitted to the payment institution so that the account is settled again.

The system has no additional risks for the payment institution or the mobile payment provider. It is based on the totally normal debit/payment institution card standards, and also cannot be obstructed. Terminal devices that accept debit cards of the payment institution or debit cards of another bank can support the system.

For the restaurateurs taking money at the table and not carrying around mobile devices etc., this proposed solution is the first choice in order to be able to accept mobile payment immediately and without investment—even if the mobile payment transaction fees would be higher with this method.

Expansion options:
One card per waiter (direct electronic association of turnover with a waiter possible without “bits of paper”)
A special “merchant card” with an incorporated beacon (is activated by insertion and can then be paired by the mobile as usual).

There are also many options for extending this further and possibly even simplifying it. The advantages remain that:
ANY installed credit card terminal with payment institution acceptance can immediately also accept mobile payment provided that the operator/trader orders a “merchant card” for mobile payment
Use of the existing “legacy” infrastructure without installation costs
Very quickly implementable
Very low costs for mobile payment provider

### LIST OF REFERENCE SYMBOLS

1 Communication path between terminal and payment institution
2 Communication path between payment institution and coordination entity
3 Communication path between coordination entity and mobile device
T Terminal
D Debit card
MG Mobile device
ZI Payment institution
KI Coordination entity
QR Quick response
B Beacon
ID Identification information

1. A method for payment handling at a payment station of a vendor using a mobile device of a purchaser,
wherein the payment station has a terminal equipped for debit cards, and the terminal is equipped with a card port, a display, an input apparatus and an interface to a payment institution,
wherein a debit card suitable for said terminal or the terminal is equipped with an element for wirelessly transmitting a debit-card-specific identification information to the mobile device, and
wherein the payment handling includes at least the following steps:
transmission of the identification information to the mobile device;
transmission or input of the purchase price into the terminal;
connection of the debit card to the terminal via the card port or triggering of a terminal-specific identifier via an input on the terminal;
and then either:
transmission of the purchase price and the identification information from the terminal to a payment institution;
transmission of the purchase price and the identification information from the payment institution to a coordination entity, unless the payment institution itself provides the coordination entity;
or:
transmission of the purchase price and the identification information from the terminal directly to a coordination entity,
and then
association of the identification information with the mobile device and transmission of the purchase price to the mobile device for authorization;
in the absence of verification of the purchaser on the mobile device, termination of the process, and
in the event of verification of the purchaser on the mobile device, transmission of the authorization from the mobile device via the coordination entity to the payment institution and prompting of the debiting of an account of the purchaser to the extent of the purchase price, including any charges incurred, or directly to the coordination entity and prompting of the debiting of an account of the purchaser to the extent of the purchase price, including any charges incurred;
transmission of confirmation of the payment from the payment institution or from the coordination entity to the terminal.

2. The method as claimed in claim 1, wherein the identification information is a code readable via a camera of the mobile device or is a piece of identification information readable via a wireless interface, the identification information being able to be provided in encrypted form.

3. The method as claimed in claim 1, wherein the identification information is provided via a Bluetooth Low Energy component, the latter being able to be arranged either on the card or on the terminal.

4. The method as claimed in claim 1, wherein the debit card is equipped with a low energy Bluetooth chip that is supplied with power on coupling of the debit card in the card port of the terminal and uses a short-range secure data transmission to transmit the identification information to the mobile device.

5. The method as claimed in claim 1, wherein the method comprises the following steps, unless specified otherwise in the following order:
1. transmission of the identification information to the mobile device;
2. transmission or input of the purchase price into the terminal and connection of the debit card to the terminal via the card port;
wherein steps 1 and 2 can also be performed at the same time or in the inverse order; and then either:
3a. transmission of the purchase price and the identification information from the terminal to a payment institution using a secure data line;
4b. transmission of the purchase price and the identification information from the payment institution to a coordination entity, unless the payment institution itself provides the coordination entity, again using a secure data line;
or
3a/4b transmission of the purchase price and the identification information from the terminal to the coordination entity using a secure data line;
and then:
5. association of the identification information with the mobile device in the or by the coordination entity;
6. transmission of the purchase price to the mobile device for authorization;
7. presentation of the amount and the authorization facility on the mobile device via an appropriate piece of software installed on the mobile device;
in the absence of verification of the purchaser on the mobile device by manual input or voice input, termination of the process, and
in the event of authorization of the purchaser on the mobile device by manual input or voice input,
8. transmission of the authorization from the mobile device to the coordination entity;
9. transmission of the authorization with associated identification information to the payment institution, unless the communication is effected directly between the coordination entity and the terminal;
10. transmission of the authorization, if need be with associated identification information, to the terminal;
11. output of the authorization on the terminal.

6. The method as claimed in claim 1, wherein the debiting of the account of the purchaser is effected via the coordination entity or via the payment institution.

7. The method as claimed in claim 1, wherein the mobile device is a tablet or a smartphone.

8. The method as claimed in claim 1, wherein the terminal is a conventional terminal for the handling of debit cards in the form of credit cards, bank cards, Maestro cards.

9. The method as claimed in claim 1, wherein the debit card is a debit card that is associated with an account of the vendor at the payment institution or the coordination entity and that additionally bears the identification information.

10. The method as claimed in claim 9, wherein no transaction or only a temporary transaction is performed on the account of the vendor that is managed at the payment institution or the coordination entity and that is associated with the debit card,
but rather this account is provided only for the communication between the terminal and the payment institution that is effected using existing infrastructure, whereas the actual monetary transaction is effected via the coordination entity and with reference to an account of the purchaser and another account of the vendor, the two of which do not necessarily have to be managed at the payment institution.

11. The method as claimed in claim 1, wherein the communication between at least one of the terminal and the payment institution, the communication between the payment institution and the coordination entity, the communication between the coordination entity and the mobile terminal, the communication between the debit card and the terminal, the communication between the coordination entity and the terminal, is effected in encrypted form.

12. The method as claimed in claim 1, wherein the identification information stored on the debit card and read by the mobile device either optically or via Bluetooth is a different piece of identification information than the one that is identification information interchanged for identification and association of the process between the debit card and the terminal, or between the terminal and the payment institution, or between the payment institution and the coordination entity, or between the terminal and the coordination entity, but the respective specifically transmitted identification information is stored in such a correlated fashion, or in databases, that an explicit association between the specific debit card used, the specific mobile device used, or the SIM card thereof, and the currently performed payment is possible.

13. A system for performing a method as claimed in claim 1, wherein it comprises
a terminal having a card port, a display, an input apparatus and an interface to a payment institution or a coordination entity or both,
a debit card having an element for wireless transmission of a piece of identification information to the mobile device, and having a magnetic strip or a chip, or both, for debit-card-specific information transmission to the terminal; unless the communication is effected directly between the terminal and the coordination entity, a payment institution in communication with the terminal and having an account of the vendor that is associated with the debit card; and a coordination entity in communication with the payment institution;
a portable mobile device of the purchaser having an interface for receiving or for reading the identification information from the debit card and an interface for communication with the coordination entity.

14. A debit card, for use in a method as claimed in claim 1, having an element in the form of at least one of a QR code, or a Bluetooth Low Energy component for wireless transmission of a piece of identification information to the mobile device, and having at least one of a magnetic strip and chip for debit-card-specific information transmission to the terminal.

15. The debit card as claimed in claim 14, wherein besides a chip for debit-card-specific information transmission to the terminal, the debit card has a Bluetooth Low Energy chip arranged on it that is supplied with power by the terminal in the event of interaction with the terminal and that is provided for short-range transmission of the identification information to the mobile device.

16. The method as claimed in claim 1, wherein the identification information is a code readable via a camera of the mobile device, in the form of a QR code, or is a piece of identification information readable via a wireless interface, via a Bluetooth interface, including via a low energy Bluetooth interface of the mobile device, the identification information being able to be provided in encrypted form, in time-dependent or encrypted form.

17. The method as claimed in claim 1, wherein the method comprises the following steps, unless specified otherwise in the following order:
1. transmission of the identification information to the mobile device, by optical or Bluetooth transmission;
2. transmission or input of the purchase price into the terminal, by input of the purchase price via a keypad on the terminal and connection of the debit card to the terminal via the card port, by pushing it into a card slot;
wherein steps 1 and 2 can also be performed at the same time or in the inverse order; and then either:
3a. transmission of the purchase price and the identification information from the terminal to a payment institution using a secure data line;
4b. transmission of the purchase price and the identification information from the payment institution to a coordination entity, unless the payment institution itself provides the coordination entity, again using a secure data line;
or
3a/4b transmission of the purchase price and the identification information from the terminal to the coordination entity using a secure data line;
and then:
5. association of the identification information with the mobile device in the or by the coordination entity;
6. transmission of the purchase price to the mobile device for authorization;
7. presentation of the amount and the authorization facility on the mobile device via an appropriate piece of software installed on the mobile device;
in the absence of verification of the purchaser on the mobile device by manual input or voice input, termination of the process, and
in the event of authorization of the purchaser on the mobile device by manual input or voice input,
8. transmission of the authorization from the mobile device to the coordination entity;
9. transmission of the authorization with associated identification information to the payment institution, unless the communication is effected directly between the coordination entity and the terminal;
10. transmission of the authorization, if need be with associated identification information, to the terminal;
11. output of the authorization, via a display or a printout, on the terminal.

18. The method as claimed in claim 1, wherein the debiting of the account of the purchaser is effected via the coordination entity or via the payment institution, the debiting of an account of the purchaser at another payment institution being effected via the coordination entity.

19. The method as claimed in claim 1, wherein the terminal is a conventional terminal for chip cards based on ISO/IEC 14443 and/or ISO/IEC 7816.

20. The method as claimed in claim 1, wherein the debit card is a debit card that is associated with an account of the vendor at the payment institution or the coordination entity and that additionally bears the identification information, in the form of a QR code readable with the mobile device or in the form of a Bluetooth Low Energy chip.

21. The method as claimed in claim 1, wherein the identification information stored on the debit card and read by the mobile device either optically or via Bluetooth is a different piece of identification information than the one that is identification information interchanged for identification and association of the process between the debit card and the terminal, or between the terminal and the payment institution, or between the payment institution and the coordination entity, or between the terminal and the coordination entity, but the respective specifically transmitted identification information is stored in such a correlated fashion, or in databases, that, at any time, an explicit association between the specific debit card used, the specific mobile device used, or the SIM card thereof, and the currently performed payment is possible.

22. The system according to claim 13, wherein it comprises
a terminal having a card port, a display, an input apparatus and a secure interface to a payment institution or a coordination entity,
a debit card having an element for wireless transmission of a piece of identification information to the mobile device, and having a magnetic strip or chip for debit-card-specific information transmission to the terminal;
unless the communication is effected directly between the terminal and the coordination entity, a payment institution in communication with the terminal and having an account of the vendor that is associated with the debit card; and a coordination entity in communication with the payment institution;
a portable mobile device of the purchaser having an interface for receiving or for reading the identification information from the debit card and an interface for communication with the coordination entity.
